(19) United States
(12) Patent Application Publication
(10) Pub. No.: US 2024/0246115 A1
(43) Pub. Date: Jul. 25, 2024

(54) VIBRATION PANEL AND TOUCH DISPLAY APPARATUS

(71) Applicants: Beijing BOE Technology Development Co., Ltd., Beijing (CN); BOE Technology Group Co., Ltd., Beijing (CN)

(72) Inventor: Yuju CHEN, Beijing (CN)

(21) Appl. No.: 18/016,264

(22) PCT Filed: Feb. 24, 2022
(86) PCT No.: PCT/CN2022/077758

§ 371 Date: Jan. 13, 2023

(51) Int. Cl. B06B 1/06; B60K 35/25; G02F 1/1333; G06F 3/01; H02N 2/00

(52) U.S. Cl. CPC B06B 1/0629; G06F 3/016; H02N 2/0075; B06B 2201/55; B60K 35/25; B60K 2360/1434; B60K 2360/816; G02F 1/13338

(57) ABSTRACT

Embodiments of the present disclosure provide a vibration panel and a touch display apparatus. The vibration panel includes: a fixed substrate; a piezoelectric device, located on the fixed substrate, and configured to generate an inverse piezoelectric effect to generate vibration under an action of an alternating voltage signal; and a vibration transmission structure, located on the piezoelectric device, and configured to transmit force generated during vibration of the piezoelectric device.

### CROSS-REFERENCE OF RELATED APPLICATIONS

The present application is a national phase entry under 35 U.S.C. § 371 of International Application No. PCT/CN2022/077758, filed on Feb. 24, 2022.

### FIELD

The present disclosure relates to the technical field of haptics, in particular to a vibration panel and a touch display apparatus.

### BACKGROUND

Haptics is a focus of science and technology development nowadays. With Haptics, a terminal can interact with the human body through tactile sense. Haptic feedback may be divided into two categories: vibration feedback and a haptic reproduction technology.

With the surface haptic reproduction technology, characteristics of objects can be perceived by touching a screen with bare fingers, thus realize efficient and natural interaction with a multimedia terminal. The surface haptic reproduction technology has a great research value, thereby having received extensive attention from researchers at home and abroad. In the physical sense, surface tactility is that surface roughness of the objects acts on a surface of the skin (fingertip). Different friction forces are formed due to different surface structures. Therefore, different haptic/tactility simulations can be realized by controlling surface friction.

### SUMMARY

Embodiments of the present disclosure provide a vibration panel and a touch display apparatus. The specific solutions are as follows.

A vibration panel provided by embodiments of the present disclosure includes:
a fixed substrate;
a piezoelectric device, located on the fixed substrate, and configured to generate an inverse piezoelectric effect to generate vibration under an action of an alternating voltage signal; and
a vibration transmission structure, located on the piezoelectric device, and configured to transmit force generated during vibration of the piezoelectric device.

In a possible implementation, in the above vibration panel provided by the embodiments of the present disclosure, the fixed substrate is a metal substrate, a glass substrate, a ceramic substrate or a printed circuit board.

In a possible implementation, in the above vibration panel provided by the embodiments of the present disclosure, the vibration transmission structure is located on a central area of the piezoelectric device.

In a possible implementation, in the above vibration panel provided by the embodiments of the present disclosure, density of the vibration transmission structure is greater than 0.01 g/cm³.

In a possible implementation, in the above vibration panel provided by the embodiments of the present disclosure, a material of the vibration transmission structure includes foam tape.

In a possible implementation, the above vibration panel provided by the embodiments of the present disclosure further includes a fixing structure connected with a side edge of the fixed substrate. The fixing structure includes a screw or viscose.

In a possible implementation, the above vibration panel provided by the embodiments of the present disclosure further includes a first adhesive layer located between the piezoelectric device and the fixed substrate. The first adhesive layer is configured to connect the piezoelectric device with the fixed substrate.

In a possible implementation, the above vibration panel provided by the embodiments of the present disclosure further includes: a conductive connection part located at an edge of the piezoelectric device, and a flexible printed circuit located between the piezoelectric devices and located on one side of the first adhesive layer facing away from the fixed substrate. The piezoelectric device is electrically connected with the flexible printed circuit through the conductive connection part.

In a possible implementation, in the above vibration panel provided by the embodiments of the present disclosure, a surface of the vibration transmission structure facing away from the fixed substrate is higher than a surface of the flexible printed circuit facing away from the fixed substrate.

In a possible implementation, in the above vibration panel provided by the embodiments of the present disclosure, a material of the conductive connection part includes conductive fabric, conductive resin or silver colloid.

In a possible implementation, in the above vibration panel provided by the embodiments of the present disclosure, the piezoelectric device includes a first electrode, a piezoelectric layer and a second electrode which are disposed sequentially in a stacked mode. The first electrode is grounded, and the second electrode is electrically connected with the flexible printed circuit through the conductive connection part.

In a possible implementation, in the above vibration panel provided by the embodiments of the present disclosure, a material of the piezoelectric layer includes at least one of lead zirconate titanate, aluminum nitride, zinc oxide, barium titanate, lead titanate, potassium niobate, lithium niobate, lithium tantalate, or langasite.

In a possible implementation, in the above vibration panel provided by the embodiments of the present disclosure, the quantity of the piezoelectric devices is multiple, and all the piezoelectric devices are uniformly distributed.

In a possible implementation, in the above vibration panel provided by the embodiments of the present disclosure, the piezoelectric devices are disposed at four corners of the fixed substrate and at a central position of the fixed substrate.

In a possible implementation, in the above vibration panel provided by the embodiments of the present disclosure, the plurality of rows and columns of the piezoelectric devices arranged in an array are disposed on the fixed substrate.

In a possible implementation, in the above vibration panel provided by the embodiments of the present disclosure, at least two piezoelectric device arrangement units are disposed on the fixed substrate. The piezoelectric device arrangement unit includes four piezoelectric devices arranged in a square and one piezoelectric device located in a center of the square.

In a possible implementation, in the above vibration panel provided by the embodiments of the present disclosure, the piezoelectric device is disposed at a central position of each side edge of the fixed substrate.

Accordingly, embodiments of the present disclosure further provide a touch display apparatus, including: the above vibration panel provided by the embodiments of the present disclosure, and a touch display panel stacked with the vibration panel. A touch surface of the touch display panel is far away from the vibration panel. The vibration transmission structure of the vibration panel and the touch display panel are disposed in a contact mode. The vibration transmission structure of the vibration panel is configured to transmit force generated by vibration of the piezoelectric device to the touch display panel, so that the touch display panel resonates to realize haptic feedback.

In a possible implementation, in the above touch display apparatus provided by the embodiments of the present disclosure, the touch display panel includes a bottom frame, a backlight module, a liquid crystal display module, a touch module and a cover plate which are disposed sequentially in a stacked mode. A peripheral area of one side of the bottom frame facing the vibration panel is provided with a second adhesive layer. The second adhesive layer is fixedly connected with the peripheral area of the fixed substrate, and the vibration transmission structure and the bottom frame are disposed in a contact mode.

In a possible implementation, in the above touch display apparatus provided by the embodiments of the present disclosure, a material of the second adhesive layer and a material of the vibration transmission structure are the same.

In a possible implementation, the above touch display apparatus provided by the embodiments of the present disclosure is applied to vehicle-mounted display, and the fixed substrate is fixed on a vehicle frame through the fixing structure of the vibration panel.

### BRIEF DESCRIPTION OF THE DRAWINGS

FIG. 1 is a schematic structural diagram of a vibration panel provided by an embodiment of the present disclosure.

FIG. 2 is a schematic structural diagram of a piezoelectric device provided by an embodiment of the present disclosure.

FIG. 3 to FIG. 6 are respectively several schematic arrangement diagrams of piezoelectric devices.

FIG. 7 is a schematic structural diagram of a touch display apparatus provided by an embodiment of the present disclosure.

FIG. 8 is a schematic structural diagram of some film layers in FIG. 7.

FIG. 9 is a schematic structural diagram illustrating vibration of a liquid crystal display module driven by vibration of a piezoelectric device.

FIG. 10 is a schematic flow diagram of realizing a haptic feedback function by a touch display apparatus.

### DETAILED DESCRIPTION OF THE EMBODIMENTS

In order to make the objective, technical solutions and advantages of the embodiments of the present disclosure clearer, the technical solutions of the embodiments of the present disclosure will be described clearly and completely below with reference to the accompanying drawings of the embodiments of the present disclosure. Obviously, the described embodiments are part of the embodiments of the present disclosure, but not all the embodiments. The embodiments in the present disclosure and features in the embodiments may be mutually combined in the case of no conflict. On the basis of the described embodiments of the present disclosure, all other embodiments obtained by those ordinarily skilled in the art without inventive efforts fall within the protection scope of the present disclosure.

Unless otherwise defined, the technical or scientific terms used in the present disclosure shall have the usual meanings understood by a person of ordinary skill in the art to which the present disclosure belongs. The word “including” or “containing” and the like used in the present disclosure, means that an element or item preceding the word covers an element or item listed after the word and the equivalent thereof, without excluding other elements or items. The word “connection” or “coupling” and the like is not restricted to physical or mechanical connection, but may include electrical connection, whether direct or indirect. The words “inner”, “outer”, “up”, “down” and the like are only used to indicate the relative positional relationship. When the absolute position of the described object changes, the relative positional relationship may also change accordingly.

It should be noted that sizes and shapes of all graphs in the accompanying drawings do not reflect the true scale, and only intend to illustrate the content of the present disclosure. The same or similar reference numbers represent the same or similar elements or elements with the same or similar functions from beginning to end.

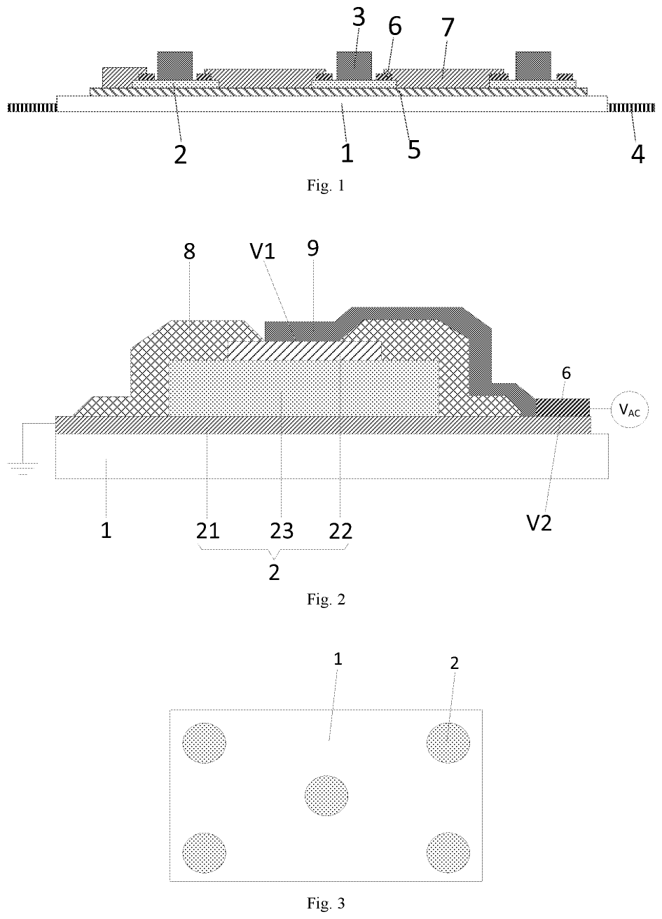

Embodiments of the present disclosure provide a vibration panel, as shown in FIG. 1, including:
a fixed substrate 1;
a piezoelectric device 2, located on the fixed substrate 1, and configured to generate an inverse piezoelectric effect to generate vibration under an action of an alternating voltage signal; and
a vibration transmission structure 3, located on the piezoelectric device 2, and configured to transmit force generated during vibration of the piezoelectric device 2.

The above vibration panel provided by the embodiments of the present disclosure may be applied in a vehicle-mounted display apparatus. When the piezoelectric device generates the inverse piezoelectric effect to generate vibration under the action of the alternating voltage signal, the force generated during vibration of the piezoelectric device is transmitted to a touch display panel of the vehicle-mounted display apparatus through the vibration transmission structure to drive the touch display panel to vibrate. When a finger of the person touches the touch display panel, both visual and haptic feedback effects are realized.

During implementations, in the above vibration panel provided by the embodiments of the present disclosure, the fixed substrate may be, but is not limited to a metal substrate, a glass substrate, a ceramic substrate or a printed circuit board. For example, when the vibration panel provided by the embodiments of the present disclosure is integrated in the vehicle-mounted display apparatus, the fixed substrate is used for fixing with a vehicle frame.

For example, the metal substrate may be an aluminum shell substrate, a stainless steel substrate, and the like. In the embodiments of the present disclosure, the fixed substrate is the aluminum shell substrate.

During implementations, in the above vibration panel provided by the embodiments of the present disclosure, as shown in FIG. 1, the vibration transmission structure 3 is located in a central area of the piezoelectric device 2. In this way, the force generated during vibration of the piezoelectric device 2 can be transmitted evenly, and a haptic feedback effect can be improved.

It should be noted that the vibration transmission structure 3 is located in the central area of the piezoelectric device 2, which can have a certain deviation range due to influence of process manufacturing.

During implementations, in the above vibration panel provided by the embodiments of the present disclosure, as shown in FIG. 1, density of the vibration transmission structure 3 is greater than 0.01 g/cm³. In this way, hardness of the vibration transmission structure 3 is relatively high, which can ensure that the vibration transmission structure 3 can transmit the force generated during vibration of the piezoelectric device 2. If the density is too small, the hardness of the vibration transmission structure 3 is relatively low, which may lead to a problem of poor vibration transmission effect.

For example, a material of the vibration transmission structure 3 includes, but is not limited to foam tape. The embodiments of the present disclosure take the material of the vibration transmission structure 3 being foam tape as an example, and of course, other materials that can transmit the force generated during vibration of the piezoelectric device 2 may further be selected for the vibration transmission structure 3.

For example, a thickness of the foam tape may be 0.1 mm to 1 mm, and the foam tape may be adhered to an upper part of the piezoelectric device through an adhesive layer.

During implementations, the above vibration panel provided by the embodiments of the present disclosure, as shown in FIG. 1, further includes a fixing structure 4 connected with a side edge of the fixed substrate 1. The fixing structure 4 includes a screw or viscose. For example, when the vibration panel provided by the embodiments of the present disclosure is used for vehicle-mounted display, the vibration panel may be fixed with the vehicle frame through the fixing structure 4.

During implementations, the above vibration panel provided by the embodiments of the present disclosure, as shown in FIG. 1, further includes a first adhesive layer 5 located between the piezoelectric device 2 and the fixed substrate 1. The first adhesive layer 5 is used to connect the piezoelectric device 2 with the fixed substrate 1. For example, the first adhesive layer 5 may be a back adhesive (gum), and a thickness of the first adhesive layer 5 may be 0.05 mm to 0.1 mm.

During implementations, the above vibration panel provided by the embodiments of the present disclosure, as shown in FIG. 1, further includes: a conductive connection part 6 located at an edge of the piezoelectric device 2, and a flexible printed circuit 7 (FPC) located between the piezoelectric devices 2 and located on one side of the first adhesive layer 5 facing away from the fixed substrate 1. The piezoelectric device 2 is electrically connected with the flexible printed circuit 7 through the conductive connection part 6. For example, the conductive connection part 6 may be conductive fabric or conductive adhesive. The flexible printed circuit 7 is provided with a wiring and gold finger structure for electrical connection with an external control circuit. The external control circuit is used to transmit the alternating voltage signal to the piezoelectric device 2 through the flexible printed circuit 7.

As shown in FIG. 2, FIG. 2 is a schematic diagram of a structure of the piezoelectric device 2 in FIG. 1. The piezoelectric device 2 includes a first electrode 21, a piezoelectric layer 23 and a second electrode 22 which are sequentially disposed in a stacked mode. The first electrode 21 is grounded, and the second electrode 22 is electrically connected with the flexible printed circuit 7 through the conductive connection part 6. The piezoelectric device 2 may further include: an insulating layer 8 located on one side of the second electrode 22 facing away from the piezoelectric layer 23, and a wiring layer 9 located on one side of the insulating layer 8 facing away from the piezoelectric layer 23. The second electrode 22 may be electrically connected with the flexible printed circuit 7 through the wiring layer 9 and the conductive connection part 6.

The insulating layer 8 is provided with a first via hole V1 disposed corresponding to the second electrode 22. One end of the wiring layer 9 is electrically connected with the second electrode 22 through the first via hole V1, and the other end of the wiring layer 9 is electrically connected with the conductive connection part 6 through a second via hole V2 penetrating through the insulating layer 8. For example, the first electrode 21 is grounded, and the conductive connection part 6 is connected with a drive voltage input end (FPC). A voltage signal input by the drive voltage input end is the alternating voltage signal. The second electrode 22 is loaded with the alternating voltage signal (V_{AC}) through the drive voltage input end, so that an alternating electric field can be formed between the second electrode 22 and the first electrode 21, and a frequency of the alternating electric field is the same as a frequency of the alternating voltage signal. Under the action of the alternating voltage signal, the piezoelectric layer 23 deforms and vibrates. The vibration transmission structure 3 transmits the force generated during vibration of the piezoelectric layer 23 to the touch display panel to realize haptic reproduction.

It should be noted that the first electrodes 21 of all the piezoelectric devices 2 in FIG. 1 may be each of a patterned structure or a whole surface structure. The piezoelectric layers 23 of all the piezoelectric devices 2 are each of a patterned structure, and the second electrodes 22 of all the piezoelectric devices 2 are each of a patterned structure in one-to-one correspondence to the piezoelectric layers 23.

During implementations, a material of the piezoelectric layer may be lead zirconate titanate (Pb(Zr, Ti)O₃, PZT), and may further be at least one of aluminum nitride (AlN), zinc oxide (ZnO), barium titanate (BaTiO₃), lead titanate (PbTiO₃), potassium niobate (KNbO₃), lithium niobate (LiNbO₃), lithium tantalate (LiTaO₃), or langasite (La₃Ga₅SiO₁₄). The material for manufacturing the piezoelectric layer may be selected according to the actual use needs of those skilled in the art, which is not limited here. When PZT is used to manufacture the piezoelectric layer, because PZT has a high piezoelectric coefficient, piezoelectric characteristics of the corresponding vibration panel are ensured, and the corresponding vibration panel may be applied to a haptic feedback device. Moreover, PZT has a high light transmittance, which will not affect display quality of a display device when it is integrated into the display device.

During implementations, the first electrode and the second electrode of the piezoelectric device may be made of indium tin oxide (ITO), or indium zinc oxide (IZO), may further be made of one of a titanium gold (Ti—Au) alloy, a titanium aluminum titanium (Ti—Al—Ti) alloy, or a titanium molybdenum (Ti—Mo) alloy, and in addition, may further be made of one of titanium (Ti), gold (Au), silver (Ag), molybdenum (Mo), copper (Cu), tungsten (W), or chromium (Cr). Those skilled in the art can dispose the above electrodes according to the actual application needs, which is not limited here.

During implementations, in the above vibration panel provided by the embodiments of the present disclosure, a material of the wiring layer may be Ti/Ni/Au.

In a possible implementation, in the above vibration panel provided by the embodiments of the present disclosure, as shown in FIG. 1, a surface of the vibration transmission structure 3 facing away from the fixed substrate 1 is higher than a surface of the flexible printed circuit 7 facing away from the fixed substrate 1. In this way, when integrating the vibration panel provided by the embodiments of the present disclosure with a touch display panel, by disposing an adhesive layer on a surface of one side of the vibration transmission structure 3 facing away from the fixed substrate 1, the vibration panel and the touch display panel may be fixed through the adhesive layer on the vibration transmission structure 3.

During implementations, in the above vibration panel provided by the embodiments of the present disclosure, as shown in FIG. 1, a material of the conductive connection part 6 includes, but is not limited to conductive fabric, conductive resin or silver colloid.

During implementations, in the above vibration panel provided by the embodiments of the present disclosure, the material of the piezoelectric layer includes at least one of lead zirconate titanate, aluminum nitride, zinc oxide, barium titanate, lead titanate, potassium niobate, lithium niobate, lithium tantalate, or langasite.

During implementations, in the above vibration panel provided by the embodiments of the present disclosure, as shown in FIG. 1 and FIG. 3-FIG. 6 (FIG. 3-FIG. 6 are schematic planar diagrams of the fixed substrate 1 and the piezoelectric devices 2 in FIG. 1), the quantity of the piezoelectric devices 2 may be multiple, and all the piezoelectric devices 2 are uniformly distributed. When the vibration panel provided by the embodiments of the present disclosure is integrated with the touch display panel of the vehicle-mounted display, the uniformly distributed piezoelectric devices 2 when vibrating can drive the touch display panel to vibrate uniformly, which can ensure that haptic feedback can be realized when the finger of the person touches any position of the touch display panel.

During implementations, in the above vibration panel provided by the embodiments of the present disclosure, as shown in FIG. 3, the piezoelectric devices 2 may be disposed at four comers of the fixed substrate 1 and at a central position of the fixed substrate 1.

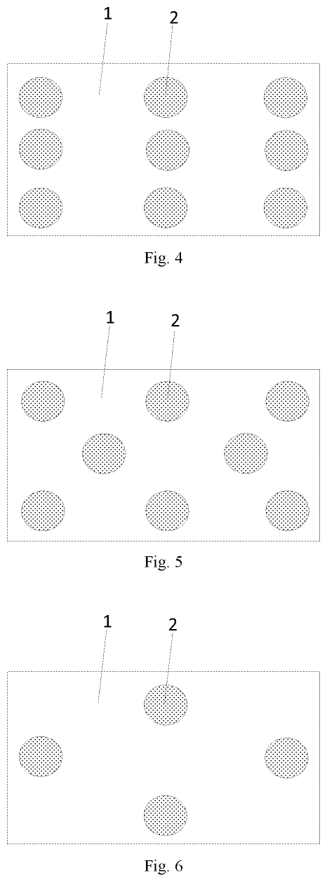

During implementations, in the above vibration panel provided by the embodiments of the present disclosure, as shown in FIG. 4, the plurality of rows and columns of the piezoelectric devices 2 arranged in an array may be disposed on the fixed substrate 1. For example, the number of rows and the number of columns of the piezoelectric devices 2 may be the same.

During implementations, in the above vibration panel provided by the embodiments of the present disclosure, as shown in FIG. 5, at least two piezoelectric device arrangement units A may be disposed on the fixed substrate 1. The piezoelectric device arrangement unit A include four piezoelectric devices 2 arranged in a square and one piezoelectric device 2 located in a center of the square.

During implementations, in the above vibration panel provided by the embodiments of the present disclosure, as shown in FIG. 6, the piezoelectric devices 2 may be disposed at a central position of each side edge of the fixed substrate 1.

It should be noted that FIG. 3-FIG. 6 illustrate only several arrangement modes of the piezoelectric devices 2 provided by the embodiments of the present disclosure, which, of course, is not limited to these, other arrangement modes can be adopted as long as the piezoelectric devices 2 are uniformly arranged on the fixed substrate 1.

It should be noted that if the fixed substrate is standard square or rectangular, the arrangement of the piezoelectric devices may preferably be centrally symmetric.

During implementations, the above vibration panel provided by the embodiments of the present disclosure may further include other film layers well known to those skilled in the art, which is not described in detail here.

The vibration panel provided by the embodiments of the present disclosure can be applied to the fields of medical care, automotive electronics, motion tracking systems, and the like. For example, the vibration panel can be applied to vehicle-mounted apparatuses and other apparatuses that can generate vibration and mechanical characteristics.

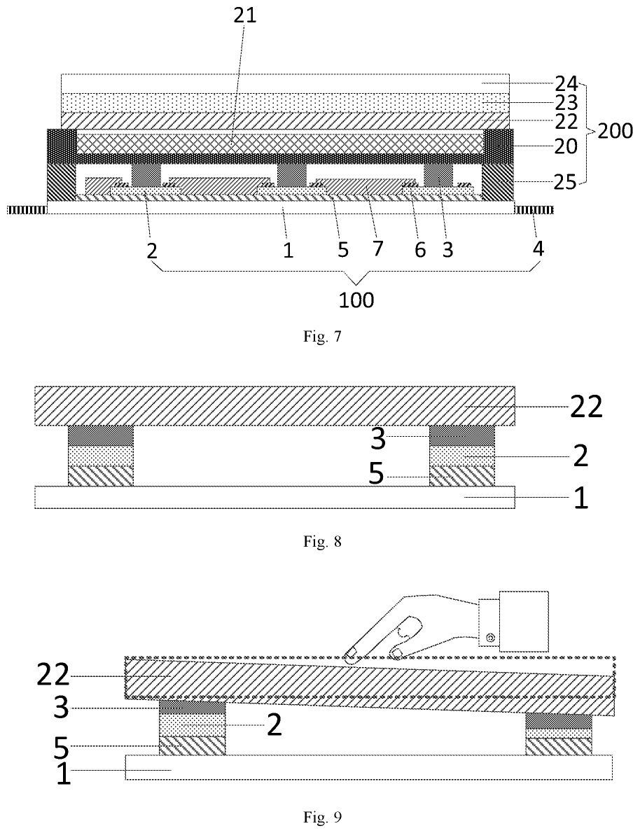

Based on the same inventive concept, embodiments of the present disclosure further provide a touch display apparatus, as shown in FIG. 7. The touch display apparatus includes: the above vibration panel 100 provided by the embodiments of the present disclosure, and a touch display panel 200 stacked with the vibration panel 100. The touch surface B of the touch display panel 200 is far away from the vibration panel 100. The vibration transmission structure 3 of the vibration panel 100 is in contact with the touch display panel 200. The vibration transmission structure 3 of the vibration panel 100 is configured to transmit force generated by vibration of the piezoelectric device 2 to the touch display panel 200, so that the touch display panel 200 resonates to realize haptic feedback.

Principles of the touch display apparatus for solving the problems are similar to that of the above vibration panel, therefore, implementation of the touch display apparatus may refer to that of the aforementioned vibration panel, and repetitions are omitted. The touch display apparatus may be: any product or component with a display or touch function, such as a mobile phone, a tablet computer, a television, a displayer, a notebook computer, a digital photo frame, and a navigator.

The above touch display apparatus provided by the embodiments of the present disclosure can realize a touch function (such as determining a touch position) and a haptic reproduction function by adopting the structure integrated with the vibration panel 100 and the touch display panel 200.

During implementations, in the above touch display apparatus provided by the embodiments of the present disclosure, as shown in FIG. 7, the touch display panel 200 includes a bottom frame 20, a backlight module 21, a liquid crystal display module 22, a touch module 23 and a cover plate 24 which are disposed sequentially in a stacked mode. A peripheral area of one side of the bottom frame 20 facing the vibration panel 100 is provided with a second adhesive layer 25. The second adhesive layer 25 is fixedly connected with the peripheral area of the fixed substrate 1. The vibration transmission structure 3 is in contact with the bottom frame 20.

For example, the vibration transmission structure 3 and the bottom frame 20 are connected by an adhesive layer.

During implementations, in the above touch display apparatus provided by the embodiments of the present disclosure, as shown in FIG. 7, a material of the second adhesive layer 25 and a material of the vibration transmission structure may be the same. That is, the material of the second adhesive layer 25 is foam tape, which is of course not limited to this.

During implementations, the above touch display apparatus provided by the embodiments of the present disclosure, as shown in FIG. 7, may be applied to vehicle-mounted display, and the fixed substrate 1 is fixed on a vehicle frame through the fixing structure 4 of the vibration panel 100.

During implementations, the connection between the backlight module 21 and the liquid crystal display module 22 may be made by gluing, and epoxy is used for connecting a display rubber frame.

During implementations, structures of the above backlight module 21, liquid crystal display module 22, and touch module 23 are the same as those of the prior art, which will not be described in detail here.

During implementation, the above touch display apparatus provided by the embodiments of the present disclosure may further include other film layers well known to those skilled in the art, which is not described in detail here.

The following illustrates a principle of realizing the haptic feedback function when the touch display apparatus provided by the embodiments of the present disclosure is applied to the vehicle-mounted field.

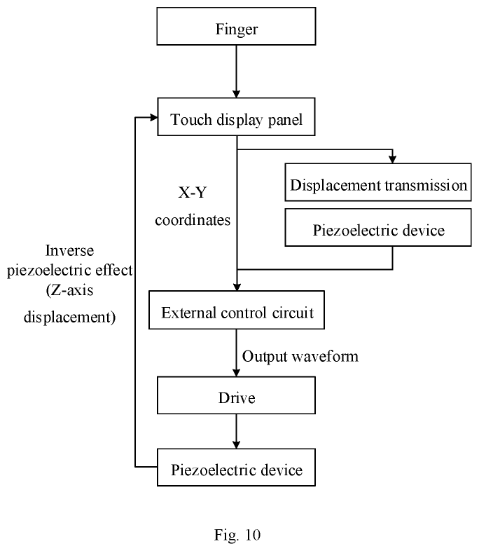

As shown in FIG. 8-FIG. 10, FIG. 8 is a schematic structural diagram of some film layers in the touch display apparatus shown in FIG. 7, FIG. 9 is a schematic structural diagram illustrating vibration of the liquid crystal display module 22 driven by vibration of the piezoelectric device in the structure shown in FIG. 8, and FIG. 10 is a schematic flow diagram of realizing a haptic feedback function.

First, a touch signal is loaded to the touch module 23. A surface of a cover plate 24 is pressed with a finger of a person, and a touch position of the finger on the touch display panel is determined (that is, an X-Y coordinate is determined) according to an electric signal fed back by a touch film layer in the touch module 23. Further, when pressed by the finger, the piezoelectric device 2 generates a positive piezoelectric effect to generate an electric signal. The touch force of the finger can be detected through the electric signal. Then, the alternating voltage signal is applied to the piezoelectric device 2 through the external control circuit (such as an MCU) to drive the piezoelectric device 2. Under the action of the alternating voltage signal, the piezoelectric device 2 generates the inverse piezoelectric effect to generate vibration, that is, vibration displacement is generated in a z-axis direction. Finally, the vibration force is transmitted to the liquid crystal display module 22 through the vibration transmission structure 3, so as to drive the liquid crystal display module 22 to vibrate and realize the haptic feedback function.

It should be noted that when the person uses his/her finger to press the surface of the cover plate 24, the finger applies a downward pressure F to the liquid crystal display module 22. When the alternating voltage signal drives the piezoelectric device 2, the piezoelectric device 2 will deform, which will produce a force F_{PZT}. If the alternating voltage signal is a ½ periodic sine wave signal, F_{PZT} is opposite to the direction of pressure F. If several continuous sine waves are loaded to the piezoelectric device 2, the force F_{PZT} is non directional, the direction of half of which is the same as the direction of pressure F, and the direction of the other half is opposite to the direction of pressure F.

For example, as shown in FIG. 9, when the finger touches, the liquid crystal display module 22 will have a tilt vibration state, so that the finger can feel the vibration and form haptic feedback. When the haptic feedback is generated, at least one piezoelectric device 2 will generate mechanical vibration. If the plurality of piezoelectric devices 2 vibrate, a vibration waveform may be the electrical signal with the same periodic frequency and voltage, but it may also be a phase difference signal with different periodic frequency and voltage.

In conclusion, the touch display apparatus provided by the embodiments of the present disclosure can realize the functions of visual and haptic reproduction and touch force detection.

During implementations, the touch display apparatus may determine the touch position of the human body, thus generating the corresponding vibration waveform, amplitude and frequency, and realizing human-computer interaction. Of course, the touch display apparatus may further be applied in the field of medical care, automotive electronics, motion tracking systems and other fields according to actual needs, which will not be detailed here.

The embodiments of the present disclosure provide the above vibration panel and the touch display apparatus, and the vibration panel may be applied in the vehicle-mounted display apparatus. When the piezoelectric device generates the inverse piezoelectric effect to generate vibration under the action of the alternating voltage signal, the force generated during vibration of the piezoelectric device is transmitted to the touch display panel of the vehicle-mounted display apparatus through the vibration transmission structure to drive the touch display panel to vibrate. When the finger of the person touches the touch display panel, the visual and haptic feedback effects are both realized.

Although the preferred embodiments of the present disclosure have been described, those skilled in the art can make additional modifications and variations on these embodiments once they know the basic creative concept. Therefore, the appended claim intends to be explained as including the preferred embodiments and all modifications and variations falling within the scope of the present disclosure.

Obviously, those skilled in the art can make various modifications and variations to the embodiment of the present disclosure without departing from the spirit and scope of the embodiment of the present disclosure. In this way, if these modifications and variations of the embodiments of the present disclosure fall within the scope of the claims of the present disclosure and their equivalent art, the present disclosure also intends to include these modifications and variations.

1. A vibration panel, comprising:
a fixed substrate;
a piezoelectric device, located on the fixed substrate, and configured to generate an inverse piezoelectric effect to generate vibration under an action of an alternating voltage signal; and
a vibration transmission structure, located on the piezoelectric device, and configured to transmit force generated during vibration of the piezoelectric device.

2. The vibration panel according to claim 1, wherein the fixed substrate is a metal substrate, a glass substrate, a ceramic substrate or a printed circuit board.

3. The vibration panel according to claim 1, wherein the vibration transmission structure is located on a central area of the piezoelectric device.

4. The vibration panel according to claim 1, wherein density of the vibration transmission structure is greater than 0.01 g/cm³.

5. The vibration panel according to claim 4, wherein a material of the vibration transmission structure comprises foam tape.

6. The vibration panel according to claim 1, further comprising:
a fixing structure connected with a side edge of the fixed substrate;
wherein the fixing structure comprises a screw or viscose.

7. The vibration panel according to claim 1, further comprising:
a first adhesive layer located between the piezoelectric device and the fixed substrate;
wherein the first adhesive layer is configured to connect the piezoelectric device with the fixed substrate.

8. The vibration panel according to claim 7, further comprising:
a conductive connection part located at an edge of the piezoelectric device; and
a flexible printed circuit located between the piezoelectric devices and located on one side of the first adhesive layer facing away from the fixed substrate;
wherein the piezoelectric device is electrically connected with the flexible printed circuit through the conductive connection part.

9. The vibration panel according to claim 8, wherein a surface of the vibration transmission structure facing away from the fixed substrate is higher than a surface of the flexible printed circuit facing away from the fixed substrate.

10. (canceled)

11. The vibration panel according to claim 8, wherein the piezoelectric device comprises:
a first electrode, a piezoelectric layer and a second electrode which are disposed sequentially in a stacked mode;
wherein the first electrode is grounded, and the second electrode is electrically connected with the flexible printed circuit through the conductive connection part.

12. The vibration panel according to claim 11, wherein a material of the piezoelectric layer comprises at least one of lead zirconate titanate, aluminum nitride, zinc oxide, barium titanate, lead titanate, potassium niobate, lithium niobate, lithium tantalate, or langasite.

13. The vibration panel according to claim 1, wherein a quantity of the piezoelectric devices is multiple, and all the piezoelectric devices are uniformly distributed.

14. The vibration panel according to claim 13, wherein the piezoelectric devices are disposed at four corners of the fixed substrate and at a central position of the fixed substrate.

15. The vibration panel according to claim 13, wherein a plurality of rows and columns of the piezoelectric devices arranged in an array are disposed on the fixed substrate.

16. The vibration panel according to claim 13, wherein at least two piezoelectric device arrangement units are disposed on the fixed substrate;
wherein the piezoelectric device arrangement unit comprises four piezoelectric devices arranged in a square and one piezoelectric device in a center of the square.

17. The vibration panel according to claim 13, wherein the piezoelectric devices are disposed at central positions of respective side edges of the fixed substrate.

18. A touch display apparatus, comprising:
the vibration panel according to claim 1; and
a touch display panel stacked with the vibration panel;
wherein, a touch surface of the touch display panel is far away from the vibration panel, the vibration transmission structure of the vibration panel is disposed in contact with the touch display panel, and the vibration transmission structure of the vibration panel is configured to transmit force generated by vibration of the piezoelectric device to the touch display panel, so that the touch display panel resonates to realize haptic feedback.

19. The touch display apparatus according to claim 18, wherein the touch display panel comprises:
a bottom frame, a backlight module, a liquid crystal display module, a touch module and a cover plate which are disposed sequentially in a stacked mode;
wherein a peripheral area of one side of the bottom frame facing the vibration panel is provided with a second adhesive layer, the second adhesive layer is fixedly connected with the peripheral area of the fixed substrate, and the vibration transmission structure is disposed in contact with the bottom frame.

20. The touch display apparatus according to claim 19, wherein a material of the second adhesive layer and a material of the vibration transmission structure are same.

21. The touch display apparatus according to claim 18, applied to vehicle-mounted display, wherein the fixed substrate is fixed on a vehicle frame through the fixing structure of the vibration panel.
